(19) United States
(12) Patent Application Publication
(10) Pub. No.: US 2011/0081580 A1
(43) Pub. Date: Apr. 7, 2011

(54) SOLID-STATE LITHIUM SECONDARY BATTERY AND METHOD FOR PRODUCING THE SAME

(75) Inventors: Florian Stadler, Munich (DE); Christopher Fietzek, Munich (DE)

(73) Assignee: SANYO ELECTRIC CO., LTD., Osaka (JP)

(21) Appl. No.: 12/894,988

(22) Filed: Sep. 30, 2010

(30) Foreign Application Priority Data
Oct. 2, 2009 (JP) 2009-230185
Jun. 30, 2010 (JP) 2010-148634

(51) Int. Cl. H01M 10/0562

(52) U.S. Cl. 429/319; 429/323

(57) ABSTRACT

A solid-state lithium secondary battery includes an electrode body including a positive electrode containing positive electrode active material particles and solid electrolyte particles, a negative electrode, and a solid electrolyte layer composed of solid electrolyte particles and disposed between the positive electrode and the negative electrode. In the solid-state lithium secondary battery, the solid electrolyte particles contained in the positive electrode and the solid electrolyte particles of the solid electrolyte layer are each composed of a lithium ion conductive material represented by chemical formula Li⁺₍₁₂₋ₙ₋ₓ₎Bⁿ⁺X²⁻₍₆₋ₓ₎Y⁻ₓ (Bⁿ⁺ is at least one selected from P, As, Ge, Ga, Sb, Si, Sn, Al, In, Ti, V, Nb, and Ta; X²⁻ is at least one selected from S, Se, and Te; Y⁻ is at least one selected from F, Cl, Br, I, CN, OCN, SCN, and N₃; and 0≦x≦2) and having an argyrodite-type crystal structure, and the positive electrode and the solid electrolyte layer are obtained by firing, at 100 to 400° C., a stacked body of a positive electrode precursor and a solid electrolyte precursor.

### CROSS REFERENCE TO RELATED APPLICATIONS:

The present invention contains subject matter related to Japanese Patent Application No. 2010-148634 filed in the Japan Patent Office on Jun. 30, 2010, the entire contents of which are incorporated herein by reference.

### BACKGROUND OF THE INVENTION

1. Field of the Invention

The present invention relates to a solid-state lithium secondary battery whose electrochemical properties are improved and a method for producing the solid-state lithium secondary battery.

2. Description of Related Art

In recent years, information-related devices and communication devices such as video cameras and cellular phones have rapidly become widespread, and thus the development of lithium secondary batteries used as the power source thereof has been regarded as important. In the automobile industry, in order to popularize electric vehicles and hybrid vehicles, which are low-emission vehicles, the development of lithium secondary batteries has been promoted. However, since an organic electrolytic solution that uses a flammable organic solvent is used in commercially available lithium secondary batteries at present, a safety device for suppressing an increase in temperature during short circuits needs to be installed or a structure or material of lithium secondary batteries needs to be improved to prevent short circuits.

Thus, unlike the lithium secondary batteries that use an organic electrolytic solution, solid-state lithium secondary batteries having the following advantages have been actively developed: an electrolyte material having no electrolyte leakage can be used; vapor pressure is not generated from an electrolyte regardless of ambient temperature; and an electrically insulating solid electrolyte functions not only as an ion conductor but also as a separator and thus significant cost reduction can be expected (refer to WO2006/059794A2 (Patent Document 1)).

Other advantages of the solid-state secondary batteries are as follows. For example, in technologically matured batteries (e.g., a battery that uses lithium phosphate oxynitride glass (represented by LiPON and having a lithium ion conductivity of about 2×10⁻⁶ S/cm) as an electrolyte), satisfactory long-term cycle characteristics can be achieved and therefore high reliability can be achieved, and also production costs can be reduced. Prominent inventions regarding a solid electrolyte relate to glass materials and amorphous materials that can be deposited, as a thin film, between a positive electrode and a negative electrode of a primary or secondary battery by various methods. In this case, the solid electrolyte layer typically has a thickness of several micrometers, and the thickness significantly depends on the usage thereof and the current when the battery is used.

In the solid-state lithium secondary batteries, it is significantly important to satisfactorily maintain the contact state between solid monolayers in order to achieve good charge/discharge rate characteristics, low polarization, stable cycle characteristics, and high charge/discharge cycle efficiency. There is a known method for producing a solid electrolyte layer by a method such as sputtering, vapor deposition, or epitaxial growth in order to bring primary particles into intimate contact with each other inside a material layer (solid electrolyte layer) and at the interface between two layers (e.g., between a positive electrode and a solid electrolyte layer). When such a method is used, an electrolyte layer obtained is dependent on the properties of a compound used. For example, when LiPON having significantly high lithium ion conductivity is sputtered in a vacuum, a thin electrolyte layer used for thin film micro lithium secondary batteries can be obtained. However, the method such as sputtering, vapor deposition, or epitaxial growth requires a long time and thus is not suitable for mass production, and also increases costs.

In view of the foregoing, there has been proposed a solid-state lithium ion secondary battery having an amorphous oxide layer that functions as a lithium ion conductor. Specifically, the solid-state lithium ion secondary battery is produced by laminating a positive electrode green sheet and a solid electrolyte green sheet to each other, removing an organic binder at 400° C. or lower, and then sintering the green sheets at high temperature (refer to US20090193648A1 (Patent Document 2)).

Furthermore, there has been proposed an electrolyte layer whose interface resistance between solid electrolyte particles is decreased by sintering lithium-ion-conductive pellet composed of a phosphoric acid compound (Li₁₊ₓAlₓGe₂₋ₓ(PO₄)₃ or Li₁₊ₓAlₓTi₂₋ₓ(PO₄)₃ (0<x<1)) at about 700 to 800° C. (refer to EP2058880A1 (Patent Document 3)).

Moreover, there has been disclosed a solid electrolyte represented by chemical formula Li⁺₍₁₂₋ₙ₋ₓ₎Bⁿ⁺X²⁻₍₆₋ₓ₎Y⁻ₓ (Bⁿ⁺ is at least one selected from P, As, Ge, Ga, Sb, Si, Sn, Al, In, Ti, V, Nb, and Ta; X²⁻ is at least one selected from S, Se, and Te; Y⁻ is at least one selected from F, Cl, Br, I, CN, OCN, SCN, and N₃; and 0≦x≦2) (refer to WO2009/047254 (Patent Document 4)). Through the exchange of information between the inventor Kong of Patent Document 4 and the inventor of this application, it is known that this solid electrolyte is not decomposed even if the temperature is increased to about 590° C. in a closed system and is melted at about 590° C.

However, the firing temperatures of the inventions disclosed in Patent Documents 2 and 3 are 700 to 1000° C., which are quite high. Therefore, the production cost of solid-state lithium secondary battery is increased because of the upsizing of a firing furnace and the increase in power consumption. In addition, the solid electrolytes disclosed in Patent Documents 2 and 3 each have a lithium ion conductivity of at most 1.3×10⁻³ S/cm, which does not satisfactorily contribute to significant improvement in battery characteristics. In Patent Document 4, a battery is not actually produced using the solid electrolyte.

### BRIEF SUMMARY OF THE INVENTION

Accordingly, an object of the present invention is to provide a solid-state lithium secondary battery whose production cost can be reduced by achieving low-temperature firing and whose battery characteristics can be significantly improved by increasing lithium ion conductivity in a solid electrolyte, and a method for producing the solid-state lithium secondary battery.

To achieve the object, the present invention provides a solid-state lithium secondary battery including an electrode body including a positive electrode containing positive electrode active material particles and solid electrolyte particles; a negative electrode containing metallic lithium or a lithium alloy; and a solid electrolyte layer composed of solid electrolyte particles and disposed between the positive electrode and the negative electrode, wherein the solid electrolyte particles contained in the positive electrode and the solid electrolyte particles of the solid electrolyte layer are each composed of a lithium ion conductive material represented by chemical formula Li⁺₍₁₂₋ₙ₋ₓ₎Bⁿ⁺H²⁻₍₆₋ₓ₎Y⁻ₓ (Bⁿ⁺ is at least one selected from P, As, Ge, Ga, Sb, Si, Sn, Al, In, Ti, V, Nb, and Ta; X²⁻ is at least one selected from S, Se, and Te; Y⁻ is at least one selected from F, Cl, Br, I, CN, OCN, SCN, and N₃; and 0≦x≦2) (hereinafter “the chemical formula”) and having an argyrodite-type crystal structure, and the positive electrode and the solid electrolyte layer are obtained by firing, at 100 to 400° C., a stacked body of a positive electrode precursor composed of the positive electrode active material particles and the solid electrolyte particles in a mixed manner and a solid electrolyte precursor composed of the solid electrolyte particles.

The lithium ion conductive material represented by the above-described chemical formula and having an argyrodite-type crystal structure has a definite crystal structure unlike a known glass material. The crystal phase can be analyzed by ⁷Li solid-state nuclear magnetic resonance (NMR) spectrometry and is known to have a significantly high intrinsic lithium ion conductivity. Specifically, the materials described in the related art have a lithium ion conductivity of at most 1.3×10⁻³ S/cm whereas the lithium ion conductive material represented by the above-described chemical formula and having an argyrodite-type crystal structure is a lithium-excess material that exhibits high intrinsic lithium ion conductivity even at room temperature (refer to H. -J. Deiseroth, S. -T. Kong, H. Eckert, J. Vannahme, C. Reiner, T. Zai, M. S Schlosser, Angew. Chem. Int. Ed. 47, 755 (2008) (Non-patent Document 1), in which the lithium ion conductivity is about 10⁻² to 10⁻³ S/cm even at room temperature).

Herein, since the lithium ion conductive material has a particulate form, simple pressurization cannot improve overall lithium ion conductivity because the boundaries between particles restrict the movement of lithium ions in the positive electrode or electrolyte layer.

Therefore, as in the configuration described above, by firing a stacked body of a positive electrode precursor and a solid electrolyte precursor, the spaces between the solid electrolyte particles and between the solid electrolyte particles and the positive electrode active material particles are decreased, and also the contact areas between the solid electrolyte particles and between the solid electrolyte particles and the positive electrode active material particles are increased. Thus, the movement of lithium ions in the positive electrode or electrolyte layer can be prevented from being restricted at the boundaries between particles, which improves lithium ion conductivity in the positive electrode and electrolyte layer and also improves lithium ion conductivity at the interface between the positive electrode and the electrolyte layer. As a result, the charge capacity of solid-state lithium secondary batteries is increased and the polarization can be reduced.

The firing temperature is controlled to 100 to 400° C. because sintering effects are not sufficiently produced and lithium ion conductivity is not sufficiently improved if the firing temperature is excessively low and a solid electrolyte is decomposed if the firing temperature is excessively high.

The present invention also provides a solid-state lithium secondary battery including an electrode body including a positive electrode containing positive electrode active material particles and solid electrolyte particles; a negative electrode containing negative electrode active material particles and solid electrolyte particles; and a solid electrolyte layer composed of solid electrolyte particles and disposed between the positive electrode and the negative electrode, wherein the solid electrolyte particles contained in the positive electrode, the solid electrolyte particles of the solid electrolyte layer, and the solid electrolyte particles contained in the negative electrode are each composed of a lithium ion conductive material represented by chemical formula Li⁺₍₁₂₋ₙ₋ₓ₎Bⁿ⁺X²⁻₍₆₋ₓ₎Y⁻ₓ (Bⁿ⁺ is at least one selected from P, As, Ge, Ga, Sb, Si, Sn, Al, In, Ti, V, Nb, and Ta; X²⁻ is at least one selected from S, Se, and Te; Y⁻ is at least one selected from F, Cl, Br, I, CN, OCN, SCN, and N₃; and 0≦x≦2) and having an argyrodite-type crystal structure, and the positive electrode, the negative electrode, and the solid electrolyte layer are obtained by firing, at 100 to 400° C., a stacked body of a positive electrode precursor composed of the positive electrode active material particles and the solid electrolyte particles in a mixed manner, a negative electrode precursor composed of the negative electrode active material particles and the solid electrolyte particles in a mixed manner, and a solid electrolyte precursor composed of the solid electrolyte particles, the solid electrolyte precursor being sandwiched between the positive electrode precursor and the negative electrode precursor.

In the above-described configuration, the same advantages as those described above are achieved, and lithium ion conductivity in the negative electrode is improved and also lithium ion conductivity at the interface between the negative electrode and the electrolyte layer is improved.

The lithium ion conductive material having an argyrodite-type crystal structure is preferably Li₆PS₅Br and the positive electrode active material particles are preferably composed of Li₄Ti₅O₁₂.

In the positive electrode, the mass ratio of the total amount of the positive electrode active material particles to the total amount of the solid electrolyte particles is preferably adjusted to be in the range of 30:70 to 95:5 and more preferably 60:40 to 90:10.

The mass ratio needs to be adjusted to be in such a range for the reason below. If the amount of the positive electrode active material particles is excessively increased, the amount of the solid electrolyte particles is excessively decreased, which results in a decrease in lithium ion conductivity in the positive electrode. If the amount of the positive electrode active material particles is excessively decreased, the capacity of the positive electrode is decreased.

To achieve the object, the present invention also provides a method for producing a solid-state lithium secondary battery including a positive electrode precursor preparation step of mixing positive electrode active material particles and solid electrolyte particles composed of a lithium ion conductive material represented by chemical formula Li⁺₍₁₂₋ₙ₋ₓ₎Bⁿ⁺X²⁻₍₆₋ₓ₎Y⁻ₓ (Bⁿ⁺ is at least one selected from P, As, Ge, Ga, Sb, Si, Sn, Al, In, Ti, V, Nb, and Ta; X²⁻ is at least one selected from S, Se, and Te; Y⁻ is at least one selected from F, Cl, Br, I, CN, OCN, SCN, and N₃; and 0≦x≦2) and having an argyrodite-type crystal structure to prepare a positive electrode precursor; a solid electrolyte precursor pellet preparation step of applying pressure to solid electrolyte particles composed of the same lithium ion conductive material as that represented by the chemical formula to prepare a solid electrolyte precursor pellet; a two-layer pellet preparation step of applying pressure while the positive electrode precursor is disposed on one surface of the solid electrolyte precursor pellet to prepare a two-layer pellet; a firing step of firing the two-layer pellet at 100 to 400° C.; and an electrode body preparation step of disposing a negative electrode containing metallic lithium or a lithium alloy on the other surface of a solid electrolyte layer in the two-layer pellet and then applying pressure to the two-layer pellet and the negative electrode to prepare an electrode body.

Furthermore, the present invention provides a method for producing a solid-state lithium secondary battery including a positive electrode precursor preparation step of mixing positive electrode active material particles and solid electrolyte particles composed of a lithium ion conductive material represented by chemical formula Li⁺₍₁₂₋ₙ₋ₓ₎Bⁿ⁺X²⁻₍₆₋ₓ₎Y⁻ₓ (Bⁿ⁺ is at least one selected from P, As, Ge, Ga, Sb, Si, Sn, Al, In, Ti, V, Nb, and Ta; X²⁻ is at least one selected from S, Se, and Te; Y⁻ is at least one selected from F, Cl, Br, I, CN, OCN, SCN, and N₃; and 0≦x≦2) and having an argyrodite-type crystal structure to prepare a positive electrode precursor; a positive electrode precursor pellet preparation step of applying pressure to the positive electrode precursor to prepare a positive electrode precursor pellet; a two-layer pellet preparation step of applying pressure while solid electrolyte particles composed of the same lithium ion conductive material as that represented by the chemical formula are disposed on one surface of the positive electrode precursor pellet to prepare a two-layer pellet; a firing step of firing the two-layer pellet at 100 to 400° C.; and an electrode body preparation step of disposing a negative electrode containing metallic lithium or a lithium alloy on a surface of a solid electrolyte layer in the two-layer pellet, the surface being opposite a surface on which the positive electrode precursor pellet has been disposed, and then applying pressure to the two-layer pellet and the negative electrode to prepare an electrode body.

Furthermore, the present invention provides a method for producing a solid-state lithium secondary battery including a positive electrode precursor preparation step of mixing positive electrode active material particles and solid electrolyte particles composed of a lithium ion conductive material represented by chemical formula Li⁺₍₁₂₋ₙ₋ₓ₎Bⁿ⁺X²⁻₍₆₋ₓ₎Y⁻ₓ (Bⁿ⁺ is at least one selected from P, As, Ge, Ga, Sb, Si, Sn, Al, In, Ti, V, Nb, and Ta; X²⁻ is at least one selected from S, Se, and Te; Y⁻ is at least one selected from F, Cl, Br, I, CN, OCN, SCN, and N₃; and 0≦x≦2) and having an argyrodite-type crystal structure to prepare a positive electrode precursor; a positive electrode precursor pellet preparation step of applying pressure to the positive electrode precursor to prepare a positive electrode precursor pellet; a solid electrolyte precursor pellet preparation step of applying pressure to solid electrolyte particles composed of the same lithium ion conductive material as that represented by the chemical formula to prepare a solid electrolyte precursor pellet; a two-layer pellet preparation step of applying pressure while the positive electrode precursor pellet is disposed on one surface of the solid electrolyte precursor pellet to prepare a two-layer pellet; a firing step of firing the two-layer pellet at 100 to 400° C.; and an electrode body preparation step of disposing a negative electrode containing metallic lithium or a lithium alloy on the other surface of a solid electrolyte layer in the two-layer pellet and then applying pressure to the two-layer pellet and the negative electrode to prepare an electrode body.

When a solid-state lithium secondary battery is produced by one of the three production methods, the firing may be performed at 100 to 400° C. (that is, firing can be performed at low temperature compared with related art). Therefore, heating energy can be decreased and a firing furnace having relatively low heat resistance can be used. Thus, the production cost of solid-state lithium secondary batteries can be significantly reduced.

When the lithium ion conductive material represented by the chemical formula and having an argyrodite-type crystal structure is used as a solid electrolyte, another advantage is achieved over the case where, for example, amorphous Li₂S—P₂S₅ glass is used as a solid electrolyte. In other words, although the glass material needs to be produced by adding high energy through mechanical crushing with a high-energy ball mill, the lithium ion conductive material having an argyrodite-type crystal structure and used in the present invention can be produced by a simple solid-state reaction including mixing and firing. Therefore, there is an advantage of not requiring the addition of high energy. Such a production method is particularly useful because weighing can be easily performed, the applicability to industry is high, and the purity of a lithium ion conductive material having an argyrodite-type crystal structure can be easily controlled, which are important aspects for battery-related applications.

In the two-layer pellet preparation step, the pressure is preferably 100 to 400 MPa and more preferably 250 to 300 MPa.

The pressure in the two-layer pellet preparation step is controlled in such a manner for the reason below. If the pressure is excessively low, the binding properties between the solid electrolyte particles and between the solid electrolyte particles and the positive electrode active material particles become insufficient, and thus the lithium ion conductivity is not sufficiently improved. On the other hand, if the pressure is excessively high, mechanical stress is increased, and thus the delamination between the solid electrolyte layer and the positive electrode or the deformation of the two-layer pellet may be caused.

In the firing step, the firing temperature is preferably 200 to 350° C. and more preferably 200 to 300° C.

The firing temperature is controlled in such a manner for the reason below. If the firing temperature is excessively low, sintering effects are not sufficiently produced and lithium ion conductivity is not sufficiently improved. If the firing temperature is excessively high, mechanical stress is increased and the two-layer pellet may be cracked or deformed.

To achieve the object, the present invention also provides a method for producing a solid-state lithium secondary battery including a positive electrode precursor preparation step of mixing positive electrode active material particles and solid electrolyte particles composed of a lithium ion conductive material represented by chemical formula Li⁺₍₁₂₋ₙ₋ₓ₎Bⁿ⁺X²⁻₍₆₋ₓ₎Y⁻ₓ (Bⁿ⁺ is at least one selected from P, As, Ge, Ga, Sb, Si, Sn, Al, In, Ti, V, Nb, and Ta; X²⁻ is at least one selected from S, Se, and Te; Y⁻ is at least one selected from F, Cl, Br, I, CN, OCN, SCN, and N₃; and 0≦x≦2) and having an argyrodite-type crystal structure to prepare a positive electrode precursor; a negative electrode precursor preparation step of mixing negative electrode active material particles and solid electrolyte particles composed of the same lithium ion conductive material as that represented by the chemical formula to prepare a negative electrode precursor; a solid electrolyte precursor pellet preparation step of applying pressure to solid electrolyte particles composed of the same lithium ion conductive material as that represented by the chemical formula to prepare a solid electrolyte precursor pellet; a three-layer pellet preparation step of applying pressure while the positive electrode precursor is disposed on one surface of the solid electrolyte precursor pellet and the negative electrode precursor is disposed on the other surface of the solid electrolyte precursor pellet to prepare a three-layer pellet; and a firing step of firing the three-layer pellet at 100 to 400° C.

In the above-described configuration, the same advantages as those described above can be achieved even at the negative electrode.

In the three-layer pellet preparation step, the pressure is preferably 100 to 400 MPa and more preferably 250 to 300 MPa. In the firing step, the firing temperature is preferably 200 to 350° C. and more preferably 200 to 300° C. The lithium ion conductive material having an argyrodite-type crystal structure is preferably Li₆PS₅Br and the positive electrode active material particles are preferably composed of Li₄Ti₅O₁₂.

Examples of the lithium ion conductive material represented by the chemical formula Li⁺₍₁₂₋ₙ₋ₓ₎Bⁿ⁺X²⁻₍₆₋ₓ₎Y⁻ₓ and having an argyrodite-type crystal structure include Li₆PS₅X (X is at least one selected from Cl, Br, and I), Li₆PSe₅X (X is at least one selected from Cl, Br, and I), Li₆PO₅X (X is at least one selected from Cl, Br, and I), and Li₇PS₆.

A method for preparing the three-layer pellet is not limited to the method in which pressure is applied while the positive electrode precursor is disposed on one surface of the solid electrolyte precursor pellet and the negative electrode precursor is disposed on the other surface. Any method can be used as long as the positive electrode precursor is disposed on one surface of the solid electrolyte precursor and the negative electrode precursor is disposed on the other surface. For example, after a two-layer pellet is prepared by applying pressure while the positive electrode precursor is disposed on one surface of the solid electrolyte precursor pellet, pressure may be applied while the negative electrode precursor is disposed on the other surface of the solid electrolyte precursor pellet. Alternatively, after a two-layer pellet is prepared by applying pressure while the negative electrode precursor is disposed on one surface of the solid electrolyte precursor pellet, pressure may be applied while the positive electrode precursor is disposed on the other surface of the solid electrolyte precursor pellet. Pressure may be applied while a negative electrode precursor pellet is disposed on one surface of the solid electrolyte precursor pellet and a positive electrode precursor pellet is disposed on the other surface.

The solid electrolyte layer is preferably as thin as possible provided that the positive electrode and the negative electrode can be electronically insulated from each other with certainty. This is because, if the solid electrolyte layer is thin, the internal resistance of batteries can be reduced.

### BRIEF DESCRIPTION OF THE SEVERAL VIEWS OF THE DRAWINGS

FIG. 1 is a photograph showing a two-layer pellet after pressing;

FIG. 2 is a schematic view of a solid-state lithium secondary battery according to the present invention;

FIG. 3 is a graph showing the relationships between charge and discharge capacities and battery voltage for an invention cell A and a comparative cell Z;

FIG. 4 shows the arrangement state of Li₆PS₅Br and the movement state of lithium ions for the comparative cell Z;

FIG. 5 shows the arrangement state of Li₆PS₅Br and the movement state of lithium ions for the invention cell A; and

FIG. 6 is a graph showing the relationships between firing temperature and discharge capacity in the first cycle for invention cells A and B1 to B4 and comparative cells Z, Y1, and Y2.

### DETAILED DESCRIPTION OF THE INVENTION

A solid-state lithium secondary battery according to the present invention and a method for producing the solid-state lithium secondary battery will now be described. The solid-state lithium secondary battery of the present invention and the method for producing the solid-state lithium secondary battery are not limited to the configurations described below, and can be suitably modified within the scope of the present invention.

### Preparation of Positive Electrode Precursor (Positive Electrode Mixture)

First, a solid electrolyte composed of Li₆PS₅Br was mixed using a ball mill to prepare solid electrolyte particles having an average particle size of 1 to 50 μm. Subsequently, positive electrode active material particles composed of lithium titanate (Li₄Ti₅O₁₂ with a particle size of about 0.1 to 10 μm, which may be referred to as LTO) whose surface was coated with carbon and the solid electrolyte particles (ionic conductor particles) were mixed to prepare a positive electrode precursor (positive electrode mixture). In this case, LTO (containing 2% of carbon as a conductive agent) and the solid electrolyte particles were mixed so that the ratio of LTO to the solid electrolyte particles was 70:30 by mass. The positive electrode active material particles and the solid electrolyte particles need to be thoroughly mixed so as to be uniformly distributed.

### Preparation of Solid Electrolyte Precursor Pellet

A press die having a diameter of 11 mm was filled with 40 mg of solid electrolyte, which was the same as that used when the positive electrode precursor had been prepared, and a pressure of about 160 MPa was then applied to the solid electrolyte with a uniaxial compression apparatus to prepare a solid electrolyte precursor pellet having a thickness of about 200 μm.

### Preparation of Two-Layer Pellet

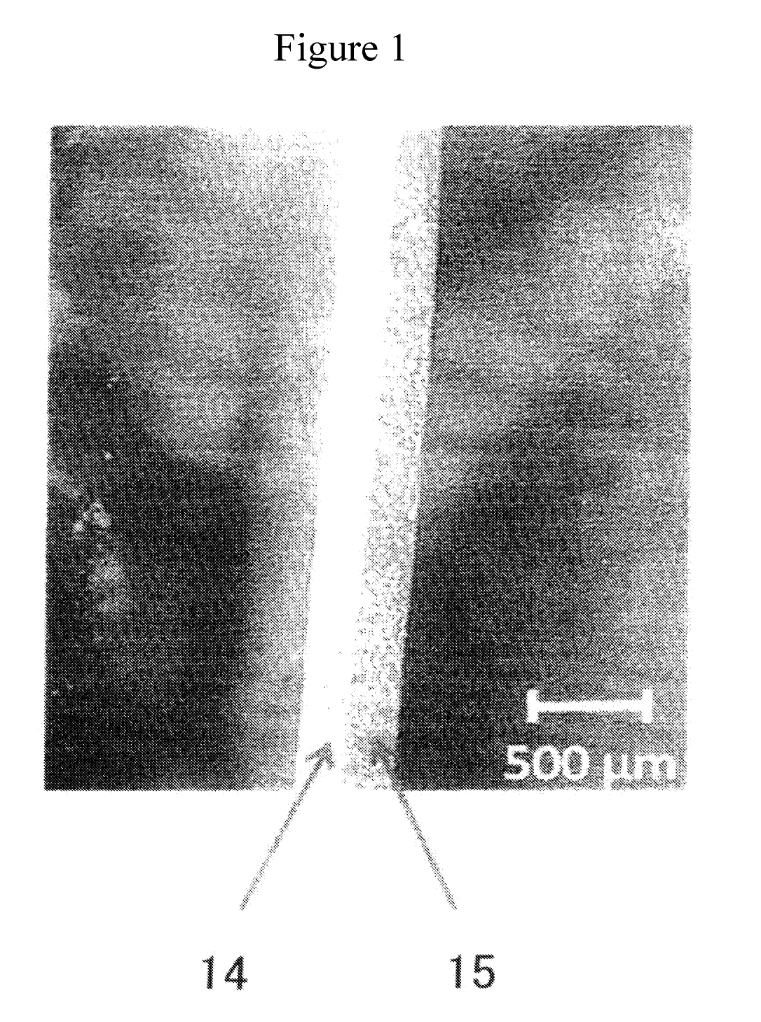

After 15 mg of the positive electrode precursor (granular form) was provided in a press die of the uniaxial compression apparatus, the solid electrolyte precursor pellet was placed on the positive electrode precursor and a pressure of about 270 MPa was applied thereto. Thus, as shown in FIG. 1, a two-layer pellet composed of a solid electrolyte precursor layer 14 and a positive electrode precursor layer 15 was formed.

### Firing of Two-Layer Pellet

The two-layer pellet was disposed between glass plates, transferred into a firing furnace, and fired in an argon atmosphere at 350° C. for 2 hours to prepare a solid electrolyte layer and a positive electrode that was in intimate contact with the solid electrolyte layer. In consideration of the further improvement in adhesion between particles through the application of pressure to the two-layer pellet during firing, the two-layer pellet was fired while being pressurized at about 0.7 MPa.

### Preparation of Negative Electrode

A lithium sheet was pressed onto an unprocessed aluminum plate (15 mm×15 mm×0.3 mm), and the plate was then held in an organic electrolyte (e.g., a solution obtained by adding lithium trifluoromethanesulfonate (LiCF₃SO₃) to 4-methyl-1,3-dioxolane so that LiCF₃SO₃ has a concentration of 0.5 mol/L) for 2 to 3 days. Subsequently, excess lithium was removed from the surface of the plate to prepare a negative electrode composed of a lithium-aluminum alloy (thickness: about 300 μm).

### Preparation of Electrode Body

The fired two-layer pellet was disposed on the negative electrode and then pressed at about 520 MPa to prepare an electrode body.

### Production of Cell

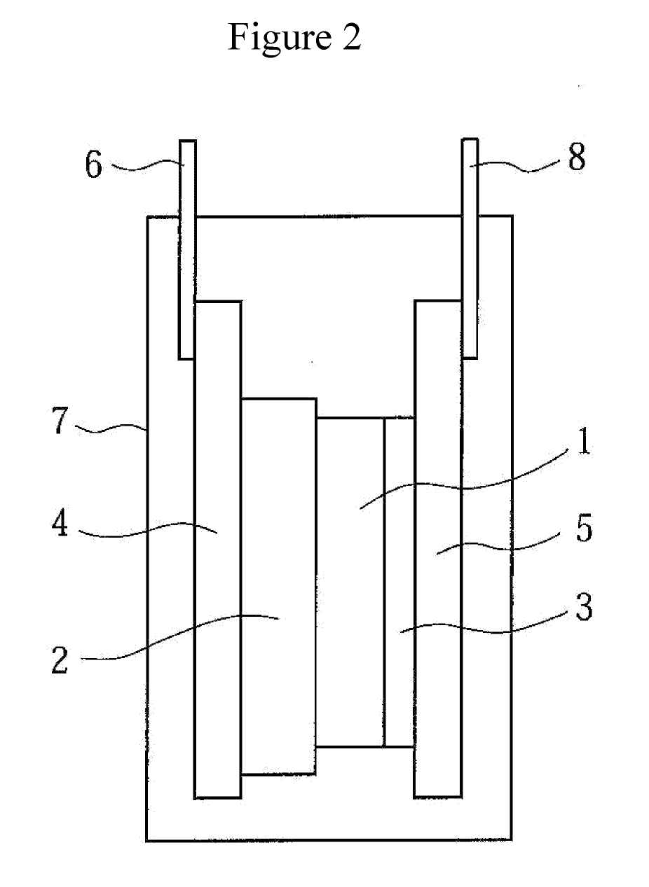

A positive electrode current collector composed of aluminum foil was fixed on the positive electrode of the electrode body and a negative electrode current collector composed of copper foil was fixed on the negative electrode. Subsequently, a negative electrode current collecting tab was fixed on the negative electrode current collector and a positive electrode current collecting tab was fixed on the positive electrode current collector. The electrode body was then sealed in an exterior body composed of aluminum laminate to produce a solid-state lithium secondary battery shown in FIG. 2. In FIG. 2, the solid-state lithium secondary battery includes a solid electrolyte layer 1, a negative electrode 2, a positive electrode 3, a negative electrode current collector 4, a positive electrode current collector 5, a negative electrode current collecting tab 6, an exterior body 7, and a positive electrode current collecting tab 8.

To prevent the oxidation and decomposition of the solid electrolyte composed of Li₆PS₅Br, the battery was produced in a glove box filled with argon throughout all the steps. The capacity of the battery was about 1 to 1.5 mAh.

The negative electrode material is not limited to a lithium-aluminum alloy, and may be other lithium alloys and metallic lithium. Furthermore, for example, negative electrode active material particles composed of graphite and the above-described solid electrolyte particles composed of Li₆PS₅Br may be used as the negative electrode. In this case, the negative electrode active material particles and the solid electrolyte particles can be simultaneously pressed and fired as in the positive electrode to prepare a negative electrode. The electrode body may include a negative electrode composed of a negative electrode active material and a solid electrolyte and a positive electrode composed of a positive electrode active material and a material (e.g., a conductive agent or a binding agent) other than a solid electrolyte.

The firing temperature of the two-layer pellet is not limited to 350° C. However, if the firing temperature is excessively low, sintering effects are not sufficiently produced and lithium ion conductivity is not sufficiently improved. If the firing temperature is excessively high, mechanical stress is increased and the two-layer pellet may be cracked or deformed. Thus, for example, when Li₆PS₅Br is used as a solid electrolyte and LTO is used as a positive electrode active material as in the above-described embodiment, the firing temperature needs to be 100 to 400° C., preferably 200 to 350° C., and more preferably 200 to 300° C.

The atmosphere during firing is not limited to the above-described argon atmosphere, and may be an inert atmosphere such as a nitrogen atmosphere or a vacuum.

### EXAMPLES

### First Example

### EXAMPLE

A test cell was prepared in the same manner as described above in the steps “Preparation of positive electrode precursor (positive electrode mixture)”; “Preparation of solid electrolyte precursor pellet”; “Preparation of two-layer pellet”; “Firing of two-layer pellet”; “Preparation of negative electrode”; “Preparation of electrode body”; and “Production of cell”.

The thus-obtained test cell is referred to as an invention cell A.

### COMPARATIVE EXAMPLE

A test cell was prepared in the same manner as in Example, except that the two-layer pellet was not fired.

The thus-obtained test cell is hereinafter referred to as a comparative cell Z.

### Experiment

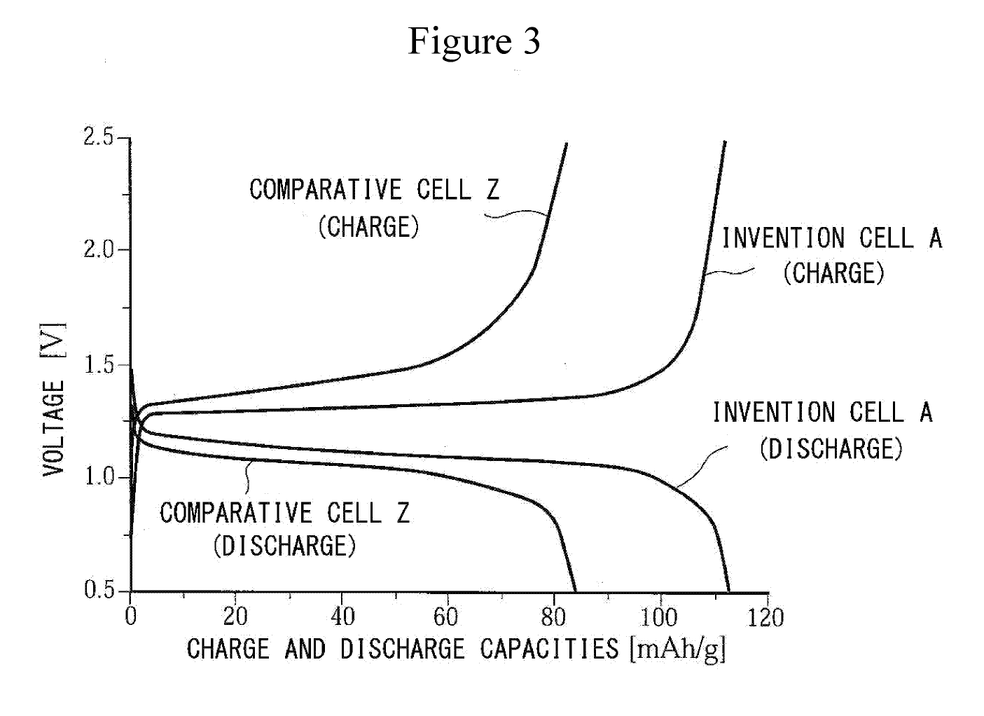

The invention cell A and the comparative cell Z were charged and discharged under the conditions below to measure charge capacity, discharge capacity, and polarization. FIG. 3 and Table 1 show the results. Charge capacity refers to the capacity in the first charge and discharge capacity refers to the capacity in the first discharge. Polarization refers to a voltage difference between charge and discharge plateaus when battery capacity is halved.

### Charge/Discharge Conditions

### Charge Conditions

Charging is performed to a battery voltage of 2.5 V (vs. Li/Li⁺) at 75° C. at a current of It/10 (about 150 μA).

### Discharge Conditions

Discharging is performed to a battery voltage of 0.5V (vs. Li/Li⁺) at 75° C. at a current of It/10 (about 150 μA).

Each of the batteries was left to stand for 10 minutes between the charge and the discharge.

TABLE 1

| | Firing | Firing | Charge | |
|---|---|---|---|---|
| | temperature | time | capacity/Discharge | Polarization |
| | [° C.] | [hour] | capacity [mAh/g] | [mV] |
| Invention | 350 | 2 | 112/112 | 220 |
| cell A | | | | |
| Comparative | — | — | 84/85 | 300 |
| cell Z | | | | |

As is clear from Table 1 and FIG. 3, the charge and discharge capacities of the invention cell A are increased by about 33% compared with those of the comparative cell Z. Furthermore, the polarization of the invention cell A is decreased by 80 mV compared with that of the comparative cell Z.

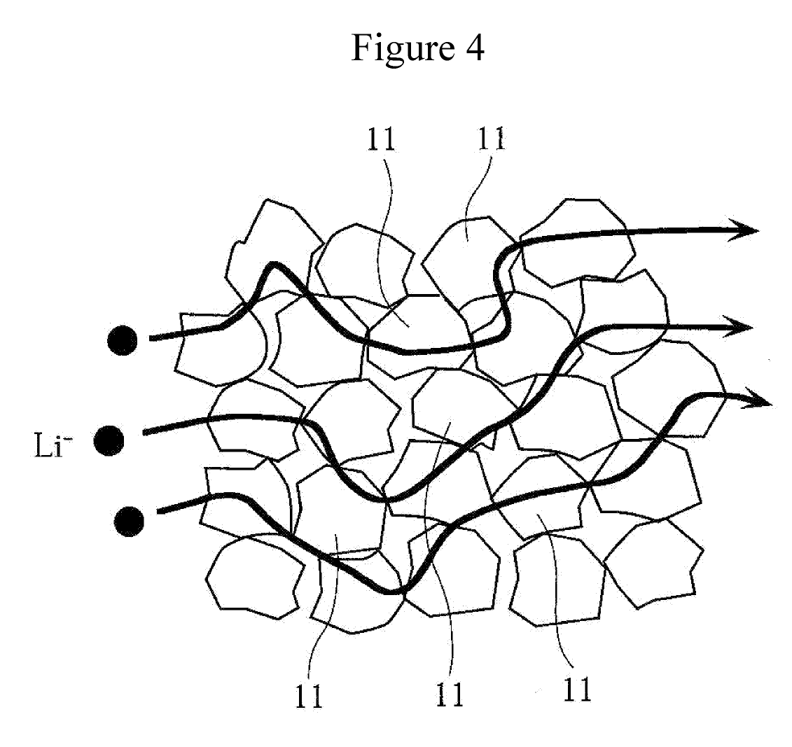

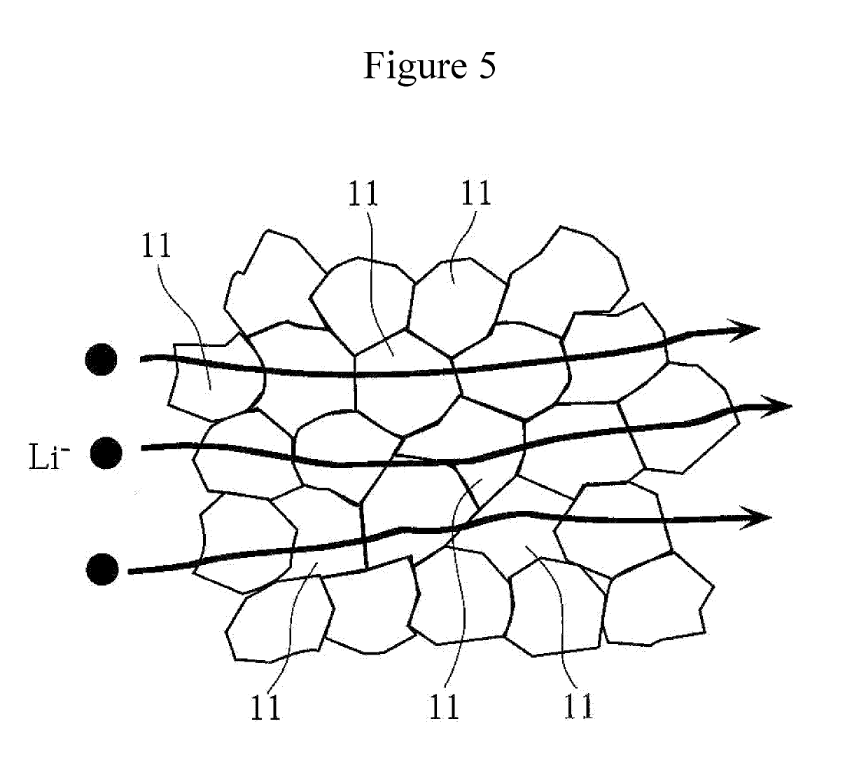

Since the two-layer pellet in the comparative cell Z is not fired, as shown in FIG. 4, the contact areas between solid electrolyte particles (Li₆PS₅Br particles) 11 in the solid electrolyte layer are decreased and thus the diffusion of lithium ions becomes slow in the electrolyte layer. Although not shown in FIG. 4, the contact areas between the solid electrolyte particles and between the solid electrolyte particles and the positive electrode active material particles in the positive electrode are also decreased and thus the diffusion of lithium ions becomes slow in the positive electrode. In contrast, since the two-layer pellet in the invention cell A is fired, as shown in FIG. 5, the contact areas between solid electrolyte particles (Li₆PS₅Br particles) 11 in the solid electrolyte layer are increased and thus the diffusion of lithium ions becomes fast in the electrolyte layer. Although not shown in FIG. 5, the contact areas between the solid electrolyte particles and the contact areas between the solid electrolyte particles and the positive electrode active material particles in the positive electrode are also increased and thus the diffusion of lithium ions becomes fast in the positive electrode. For this reason, it is believed that, in the invention cell A, the charge and discharge capacities can be increased and the polarization can be decreased compared with those of the comparative cell Z. Although not shown in Table 1, it is believed that the load characteristics of the invention cell A are improved compared with those of the comparative cell Z because of the reason described above.

### Second Example

### Example 1

A test cell was prepared in the same manner as in Example of First Example, except that the two-layer pellet was fired at 100° C. for 3 hours.

The thus-obtained test cell is hereinafter referred to as invention cell B1.

### Examples 2 to 4

Test cells were prepared in the same manner as in Example 1, except that the respective two-layer pellets were fired at 200° C., 300° C., and 400° C.

The thus-obtained test cells are hereinafter referred to as invention cells B2 to B4, respectively.

### Comparative Examples 1 and 2

Test cells were prepared in the same manner as in Example 1, except that the respective two-layer pellets were fired at 450° C. and 550° C.

The thus-obtained test cells are hereinafter referred to as comparative cells Y1 and Y2, respectively.

### Experiment

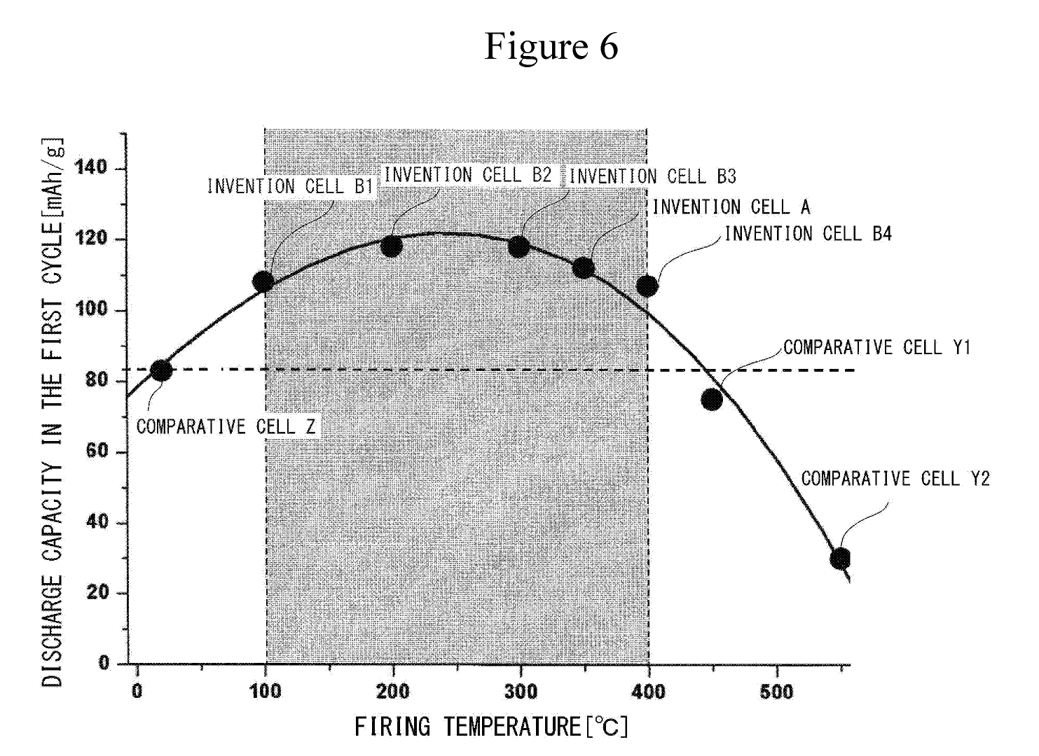

The invention cells B2 to B4 and the comparative cells Y1 and Y2 were charged and discharged under the same conditions as those shown in the experiment of First Example to measure charge capacity, discharge capacity, and polarization. FIG. 6 and Table 2 show the results. Charge capacity refers to the capacity in the first charge and discharge capacity refers to the capacity in the first discharge. Polarization refers to a voltage difference between charge and discharge plateaus when battery capacity is halved. In FIG. 6 and Table 2, the experimental results of the invention cell A and the comparative cell Z are also described to ease understanding.

TABLE 2

| | | | Charge | |
|---|---|---|---|---|
| | | | capacity/ | |
| | Firing | Firing | Discharge | |
| | temperature | time | capacity | Polarization |
| Type of battery | [° C.] | [hour] | [mAh/g] | [mV] |
| Comparative cell Z | — | — | 84/85 | 300 |
| Invention cell B1 | 100 | 3 | 122/108 | 280 |
| Invention cell B2 | 200 | | 133/118 | 230 |
| Invention cell B3 | 300 | | 122/118 | 260 |
| Invention cell A | 350 | 2 | 112/112 | 220 |
| Invention cell B4 | 400 | 3 | 140/107 | 240 |
| Comparative cell Y1 | 450 | | 73/75 | 390 |
| Comparative cell Y2 | 550 | | 30/30 | 950 |

As is clear from FIG. 6 and Table 2, the charge and discharge capacities of the invention cells A and B1 to B4 are increased compared with those of the comparative cells Z, Y1, and Y2, and the polarization of the invention cells A and B1 to B4 is decreased compared with that of the comparative cells Z, Y1, and Y2.

By comparing the solid electrolytes of the invention cells A and B1 to B4 with those of the comparative cells Y1 and Y2, it is recognized that the solid electrolytes of the invention cells A and B1 to B4 whose firing temperature is 100 to 400° C. are not decomposed, but the solid electrolytes of the comparative cells Y1 and Y2 whose firing temperature is 450° C. or more are decomposed.

Herein, it is known that, when the solid electrolyte used in the present invention is utilized in a closed system, the solid electrolyte is not decomposed at a temperature of up to about 590° C. and is melted at about 590° C. Therefore, it can be considered that the solid electrolyte should be fired at lower than 590° C. However, the inventors of this application found that when the solid electrolyte is used in an open system, for example, when the solid electrolyte is used as a material of solid-state lithium secondary batteries, the solid electrolyte is decomposed at about 450° C. The solid electrolyte in a closed system exhibits a behavior different from that in an open system in such a manner because of the reason described below. In a closed system, when the solid electrolyte is sublimated with a temperature increase, the pressure in the system is increased and therefore the solid electrolyte is melted without being decomposed as described above. In contrast, in an open system, even if the solid electrolyte is sublimated with a temperature increase, the pressure in the system is not increased and therefore the solid electrolyte is decomposed as described above.

Accordingly, the firing temperature needs to be controlled to 400° C. or lower. In the present invention, the firing temperature of the solid electrolyte is controlled to 100° C. or higher. This is because if the firing temperature is excessively low, sintering effects are not sufficiently produced and lithium ion conductivity is not sufficiently improved.

It is also recognized that the discharge capacities of the invention cells A, B2, and B3 are larger than those of the invention cells B1 and B4. This is because a firing temperature of 200° C. or higher further produces sintering effects and thus the lithium ion conductivity is sufficiently improved whereas a firing temperature of 350° C. (particularly 300° C.) or lower suppresses the generation of mechanical stress and thus the cracking or deformation of the pellet can be suppressed.

The present invention can be applied to, for example, a driving power supply of mobile information terminals such as cellular phones, laptop computers, and personal digital assistants (PDAs).

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A solid-state lithium secondary battery comprising:
an electrode body including:
a positive electrode containing positive electrode active material particles and solid electrolyte particles;
a negative electrode containing metallic lithium or a lithium alloy; and
a solid electrolyte layer composed of solid electrolyte particles and disposed between the positive electrode and the negative electrode,
wherein the solid electrolyte particles contained in the positive electrode and the solid electrolyte particles of the solid electrolyte layer are each composed of a lithium ion conductive material represented by chemical formula Li⁺₍₁₂₋ₙ₋ₓ₎Bⁿ⁺X²⁻₍₆₋ₓ₎Y⁻ₓ (Bⁿ⁺ is at least one selected from P, As, Ge, Ga, Sb, Si, Sn, Al, In, Ti, V, Nb, and Ta; X²⁻ is at least one selected from S, Se, and Te; Y⁻ is at least one selected from F, Cl, Br, I, CN, OCN, SCN, and N₃; and 0≦x≦2) and having an argyrodite-type crystal structure, and
the positive electrode and the solid electrolyte layer are obtained by firing, at 100 to 400° C., a stacked body of a positive electrode precursor composed of the positive electrode active material particles and the solid electrolyte particles in a mixed manner and a solid electrolyte precursor composed of the solid electrolyte particles.

2. A solid-state lithium secondary battery comprising:
an electrode body including:
a positive electrode containing positive electrode active material particles and solid electrolyte particles;
a negative electrode containing negative electrode active material particles and solid electrolyte particles; and
a solid electrolyte layer composed of solid electrolyte particles and disposed between the positive electrode and the negative electrode,
wherein the solid electrolyte particles contained in the positive electrode, the solid electrolyte particles of the solid electrolyte layer, and the solid electrolyte particles contained in the negative electrode are each composed of a lithium ion conductive material represented by chemical formula Li⁺₍₁₂₋ₙ₋ₓ₎Bⁿ⁺X²⁻₍₆₋ₓ₎Y⁻ₓ (Bⁿ⁺ is at least one selected from P, As, Ge, Ga, Sb, Si, Sn, Al, In, Ti, V, Nb, and Ta; X²⁻ is at least one selected from S, Se, and Te; Y⁻ is at least one selected from F, Cl, Br, I, CN, OCN, SCN, and N₃; and 0≦x≦2) and having an argyrodite-type crystal structure, and
the positive electrode, the negative electrode, and the solid electrolyte layer are obtained by firing, at 100 to 400° C., a stacked body of a positive electrode precursor composed of the positive electrode active material particles and the solid electrolyte particles in a mixed manner, a negative electrode precursor composed of the negative electrode active material particles and the solid electrolyte particles in a mixed manner, and a solid electrolyte precursor composed of the solid electrolyte particles, the solid electrolyte precursor being sandwiched between the positive electrode precursor and the negative electrode precursor.

3. The solid-state lithium secondary battery according to claim 1, wherein the lithium ion conductive material having an argyrodite-type crystal structure is Li₆PS₅Br.

4. The solid-state lithium secondary battery according to claim 2, wherein the lithium ion conductive material having an argyrodite-type crystal structure is Li₆PS₅Br.

5. The solid-state lithium secondary battery according to claim 1, wherein the positive electrode active material particles are composed of Li₄Ti₅O₁₂.

6. The solid-state lithium secondary battery according to claim 2, wherein the positive electrode active material particles are composed of Li₄Ti₅O₁₂.

7. The solid-state lithium secondary battery according to claim 3, wherein the positive electrode active material particles are composed of Li₄Ti₅O₁₂.

8. The solid-state lithium secondary battery according to claim 4, wherein the positive electrode active material particles are composed of Li₄Ti₅O₁₂.

9. The solid-state lithium secondary battery according to claim 1, wherein, in the positive electrode, the mass ratio of the total amount of the positive electrode active material particles to the total amount of the solid electrolyte particles is in the range of 30:70 to 95:5.

10. The solid-state lithium secondary battery according to claim 2, wherein, in the positive electrode, the mass ratio of the total amount of the positive electrode active material particles to the total amount of the solid electrolyte particles is in the range of 30:70 to 95:5.

11. The solid-state lithium secondary battery according to claim 3, wherein, in the positive electrode, the mass ratio of the total amount of the positive electrode active material particles to the total amount of the solid electrolyte particles is in the range of 30:70 to 95:5.

12. The solid-state lithium secondary battery according to claim 4, wherein, in the positive electrode, the mass ratio of the total amount of the positive electrode active material particles to the total amount of the solid electrolyte particles is in the range of 30:70 to 95:5.

13. The solid-state lithium secondary battery according to claim 5, wherein, in the positive electrode, the mass ratio of the total amount of the positive electrode active material particles to the total amount of the solid electrolyte particles is in the range of 30:70 to 95:5.

14. The solid-state lithium secondary battery according to claim 6, wherein, in the positive electrode, the mass ratio of the total amount of the positive electrode active material particles to the total amount of the solid electrolyte particles is in the range of 30:70 to 95:5.

15. The solid-state lithium secondary battery according to claim 7, wherein, in the positive electrode, the mass ratio of the total amount of the positive electrode active material particles to the total amount of the solid electrolyte particles is in the range of 30:70 to 95:5.

16. The solid-state lithium secondary battery according to claim 8, wherein, in the positive electrode, the mass ratio of the total amount of the positive electrode active material particles to the total amount of the solid electrolyte particles is in the range of 30:70 to 95:5.

17. The solid-state lithium secondary battery according to claim 9, wherein the mass ratio of the total amount of the positive electrode active material particles to the total amount of the solid electrolyte particles is in the range of 60:40 to 90:10.

18. The solid-state lithium secondary battery according to claim 10, wherein the mass ratio of the total amount of the positive electrode active material particles to the total amount of the solid electrolyte particles is in the range of 60:40 to 90:10.
